(19) United States
(12) Patent Application Publication
(10) Pub. No.: US 2025/0346055 A1
(43) Pub. Date: Nov. 13, 2025

(54) CONTROL APPARATUS, RECORDING APPARATUS, METHOD, AND NON-TRANSITORY COMPUTER-READABLE STORAGE MEDIUM

(71) Applicant: CANON KABUSHIKI KAISHA, Tokyo (JP)

(72) Inventor: Yukiko Kohara, Chiba (JP)

(21) Appl. No.: 19/195,849

(22) Filed: May 1, 2025

(30) Foreign Application Priority Data
May 8, 2024 (JP) 2024-076086

(51) Int. Cl. B41J 29/393; B41J 3/46; B41M 3/00; G06K 15/02; G06K 15/10

(52) U.S. Cl. CPC B41J 29/393; B41J 3/46; B41M 3/001; B41M 3/008; G06K 15/027; G06K 15/102; B41J 2029/3935

(57) ABSTRACT

At least one processor performs control of forming a plurality of print alignment patterns on a recording medium based on a first print alignment mode in which a second pattern formed with a processing liquid based on second image data is formed to be partially shifted with respect to a first pattern formed with ink based on first image data. The first pattern includes a reference pattern used for alignment with the second pattern. The second pattern includes an adjustment pattern used for alignment with the first pattern and a periodic pattern in which the ink and the processing liquid react with each other. A part of the second pattern formed to be partially shifted is the adjustment pattern.

### BACKGROUND OF THE INVENTION

### Field of the Invention

The present invention relates to a control apparatus, a recording apparatus, a method, and a non-transitory computer-readable storage medium.

### Description of the Related Art

For a recording apparatus applied with an inkjet recording method, a recording method is known in which an image is formed using ink as a printing agent and a colorless and transparent processing liquid for the purpose of improving water resistance of an image and achieving a high density image and an image without bleeding between colors. A recording apparatus that forms an image using ink and a processing liquid is equipped with an alignment pattern forming function for alignment of recording positions of the ink and the processing liquid. However, since a colorless and transparent processing liquid is used, a sufficient density for reading with an optical sensor cannot be obtained, and visual judgment is also difficult. Methods for appropriately aligning the recording positions of the colorless and transparent processing liquid and the ink include the following method. For example, a method of changing a relative recording position of a processing liquid and ink according to a plurality of misalignment amounts in order to reduce the influence of a print medium and an external environment at the time of performing printing is disclosed (Japanese Patent Laid-Open No. 2001-138494). A pattern forming method for forming a plurality of patterns indicating different optical properties as a result of contact between a processing liquid and ink on a print medium is disclosed (Japanese Patent Laid-Open No. 2001-138494).

### SUMMARY OF THE INVENTION

According to the present invention, it is possible to provide a print alignment technique for obtaining a reaction suitable for ink and a processing liquid.

Some embodiments of the present disclosure provide a control apparatus comprising at least one processor, and at least one memory coupled to the at least one processor, the at least one memory storing instructions that, when executed by the at least one processor, cause the at least one processor to perform control of forming a plurality of print alignment patterns on a recording medium based on a first print alignment mode in which a second pattern formed with a processing liquid based on second image data is formed to be partially shifted with respect to a first pattern formed with ink based on first image data, the first pattern includes a reference pattern used for alignment with the second pattern, the second pattern includes an adjustment pattern used for alignment with the first pattern and a periodic pattern in which the ink and the processing liquid react with each other, and a part of the second pattern formed to be partially shifted is the adjustment pattern.

Some embodiments of the present disclosure provide a method comprising performing control of forming a plurality of print alignment patterns on a recording medium based on a first print alignment mode in which a second pattern formed with a processing liquid based on second image data is formed to be partially shifted with respect to a first pattern formed with ink based on first image data, the first pattern includes a reference pattern used for alignment with the second pattern, the second pattern includes an adjustment pattern used for alignment with the first pattern and a periodic pattern in which the ink and the processing liquid react with each other, and a part of the second pattern formed to be partially shifted is the adjustment pattern.

Some embodiments of the present disclosure provide a non-transitory computer readable storage medium storing instructions that, when executed by a computer, cause the computer to perform a method comprising performing control of forming a plurality of print alignment patterns on a recording medium based on a first print alignment mode in which a second pattern formed with a processing liquid based on second image data is formed to be partially shifted with respect to a first pattern formed with ink based on first image data, the first pattern includes a reference pattern used for alignment with the second pattern, the second pattern includes an adjustment pattern used for alignment with the first pattern and a periodic pattern in which the ink and the processing liquid react with each other, and a part of the second pattern formed to be partially shifted is the adjustment pattern.

Further features of the present invention will become apparent from the following description of exemplary embodiments (with reference to the attached drawings).

### BRIEF DESCRIPTION OF THE DRAWINGS

FIG. 1 is a view illustrating a schematic configuration of a recording apparatus according to a first embodiment.

FIG. 2 is a cross-sectional view of the recording apparatus according to the first embodiment.

FIG. 3A is a schematic diagram of a print alignment pattern according to the first embodiment.

FIG. 3B is a schematic diagram of a print alignment pattern according to the first embodiment.

FIG. 3C is a schematic diagram of a plurality of print alignment patterns according to the first embodiment printed on a recording medium.

FIG. 4A is a schematic diagram illustrating a print alignment pattern according to a prior art.

FIG. 4B is a schematic diagram illustrating a print alignment pattern according to the prior art.

FIG. 4C is a schematic diagram of a plurality of print alignment patterns according to the prior art printed on a recording medium.

FIG. 5A is a view illustrating a setting of print alignment according to the first embodiment.

FIG. 5B is a view illustrating a setting of print alignment according to a second embodiment.

FIG. 5C is a view illustrating a setting of print alignment according to a third embodiment.

FIG. 6 is a flowchart showing a print position adjustment process according to the first embodiment.

FIG. 7 is a flowchart showing a print position adjustment process according to the second embodiment.

FIG. 8 is a flowchart showing a print position adjustment process according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate.

Furthermore, in the attached drawings, the same reference numerals are given to the same or similar configurations, and redundant description thereof is omitted.

### First Embodiment

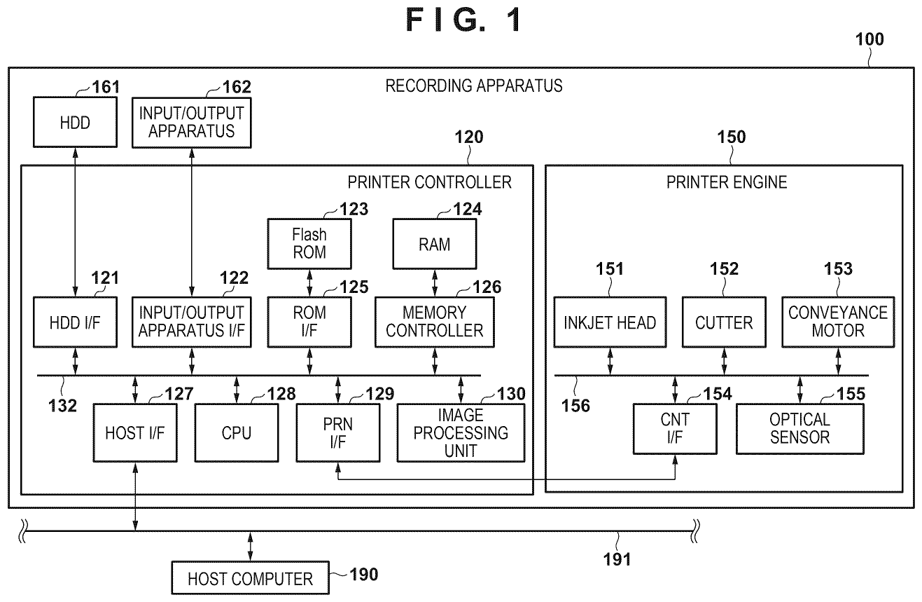

FIG. 1 is a view illustrating a schematic configuration of a recording apparatus according to the first embodiment. Note that in the present embodiment, a recording apparatus 100 has only a print function, but is not limited to this. For example, the recording apparatus 100 may function as a copying machine further including a reading apparatus that reads an image on a document, or may function as a multi-function peripheral (MFP) having other functions.

The recording apparatus 100 includes a printer controller 120, a printer engine 150, a HDD 161, and an input/output apparatus 162. The recording apparatus 100 can be connected to a host computer 190 via a network 191.

The printer controller 120 includes an HDD I/F 121, an input/output apparatus I/F 122, a ROM I/F 125, and a memory controller 126. The printer controller 120 includes a host I/F 127, a CPU 128, a controller engine I/F (PRN) 129, and an image processing unit 130. Each unit of the printer controller 120 is connected via a system bus 132. Furthermore, the printer controller 120 includes a flash ROM 123 and a RAM 124. The flash ROM 123 and the RAM 124 are connected to the system bus 132 via the ROM I/F 125 and the memory controller 126, respectively.

The CPU 128 is a central processing unit in the form of a microprocessor (microcomputer), and controls the entire operation of the recording apparatus 100 by executing a program and activating hardware.

The flash ROM 123 stores programs to be executed by the CPU 128, images, and various data necessary for various operations of the recording apparatus 100.

The RAM 124 is used as a work area for the CPU 128 and as a temporary storage area for various reception data. The RAM 124 stores various setting data.

The image processing unit 130 performs various types of image processing. The image processing unit 130 performs, for example, processing of developing (converting) print data (e.g., data represented in a page description language) handled by the recording apparatus 100 into image data (bitmap image data) and other image processing. The image processing unit 130 converts a color space (e.g., YCbCr) of image data included in input print data into a standard RGB color space (e.g., sRGB). The image processing unit 130 performs, on the image data as necessary, various image processing such as resolution conversion to an effective number of pixels (printable by the recording apparatus 100), image analysis, and image correction. The image data obtained by these image processing is stored in the RAM 124 or the HDD 161. The image data includes, for example, first image data and second image data. The first image data is image data for forming a first pattern 300 described later formed of ink. The second image data is image data for forming a second pattern described later formed of a processing liquid.

The printer engine 150 is a printing unit that forms an image. The printer engine 150 includes an inkjet head 151, a cutter unit 152, a conveyance motor 153, an interface 154 with the printer controller 120, and an optical sensor 155. Each unit is connected via a system bus 156.

The inkjet head 151 is a print unit that prints an image, and prints an image on a sheet based on image data. The inkjet head 151 holds, for example, a plurality of print heads for a plurality of colors. In synchronization with conveyance of the sheet, ink is ejected from the print head to form an image on the sheet. Note that the recording apparatus 100 according to the present embodiment is an inkjet type printer using ink as a recording material, but is not limited to this. The present invention is applicable to printing apparatuses of various printing methods such as an electrophotographic method such as thermal printers (sublimation type, thermal transfer type, and the like), dot impact printers, LED printers, and laser printers.

The cutter unit 152 is a mechanism that cuts roll paper used as a recording medium for printing. The cutter unit 152 cuts, to a predetermined length, the roll paper after image print. Note that in the case of a paper type in which paper dust is scattered when cut by the cutter unit 152, the setting of drawing a cut waste reduction line at the cutting position is stored in the flash ROM 123 in order to prevent paper dust from scattering at the time of cutting. Independently of the cut waste reduction line setting, the operation setting of the cutter unit 152 can be stored in the flash ROM 123 for each paper type. In the case where the cutter unit 152 is a paper type that cannot be cut by the cutter unit 152, a setting (hereinafter, user cut setting) in which the user does not move the cutter unit 152 to cut with scissors is stored in the flash ROM 123. In the case of a paper type in which a straight line to be cut is bent unless the user cuts the roll paper while pressing it, the setting (hereinafter, eject cut setting) in which the cutter unit 152 moves by the user's operation is stored in the flash ROM 123. In the case of a paper type in which user cut setting and eject cut setting are not performed, setting (auto cut setting) of automatically cutting by the cutter unit 152 is stored in the flash ROM 123.

The conveyance motor 153 is a motor for driving a conveyance roller that conveys the roll paper, and is controlled by the CPU 128.

The optical sensor 155 is a measurement unit for measuring an attribute value of the recording medium. The optical sensor 155 is a reflective optical sensor including a light emitting diode (LED) as a light emitting element, a specular reflection light receiving element, and a diffuse light receiving element. Using the optical sensor 155, the recording apparatus 100 measures attribute values such as intensities of specular reflection light and diffuse reflected light of the paper on a platen, and a thickness of the paper.

The input/output apparatus 162 includes hardware keys for the user to perform various operations, a panel, and a display unit that displays various types of information to the user. The input/output apparatus 162 may notify the user of information by outputting an audio (e.g., a buzzer, a sound, and the like) based on audio information from a sound generator. At the time of feeding paper, the user selects a paper type using the input/output apparatus 162 and transmits a correct paper type to the recording apparatus 100. This enables the recording apparatus 100 to perform conveyance set for each paper type.

The HDD 161 is a nonvolatile storage area, and can store and read a program to be executed by the CPU 128, print data, and setting information necessary for various operations of the recording apparatus 100. Note that in place of the HDD 161, another mass storage apparatus such as a flash memory may be used.

Note that in the present embodiment, the input/output apparatus 162 exists inside the recording apparatus 100, but is not limited to this, and may be connected to the recording apparatus 100 as an external configuration via the network 191, for example. The host computer 190 may have the function of the input/output apparatus 162. In addition to the input/output apparatus 162, another input/output apparatus (not illustrated) may be further connected to the recording apparatus 100 via the network 191 or the like.

The host computer 190 is an external apparatus serving as a supply source of print data, for example. A printer driver is installed in the host computer 190. In place of the host computer 190, for example, a data providing apparatus serving as a supply source of print data, such as a reader for reading an image, a digital camera, and a smartphone, may be provided. The connection form between each unit and the recording apparatus 100 is not limited to that via the network 191, and may be direct connection by wireless communication, for example.

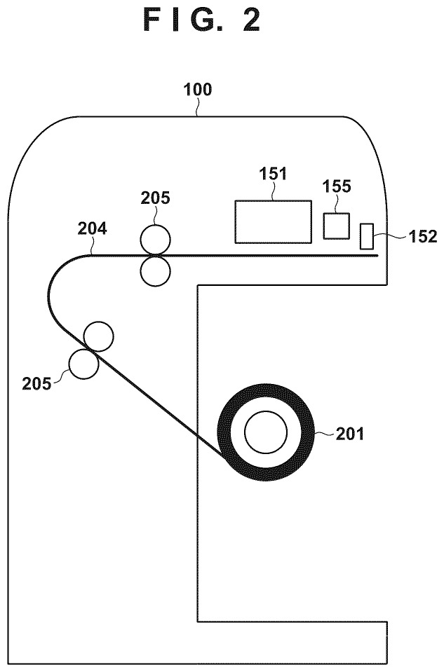

FIG. 2 is a cross-sectional view of the recording apparatus according to the first embodiment. FIG. 2 illustrates components of the recording apparatus 100 related to conveyance of roll paper 204.

The recording apparatus 100 includes a paper feed unit 201. The roll paper can be installed in the paper feed unit 201. In FIG. 2, the roll paper 204 from the paper feed unit 201 is conveyed along a conveyance path by a conveyance roller 205. The roll paper 204 is measured by the optical sensor 155 provided at a position facing the platen. The inkjet head 151 ejects ink onto the roll paper 204 conveyed from the paper feed unit 201, whereby an image is printed. At the time of feeding paper, the recording apparatus 100 lifts the roll paper 204 placed on the paper feed unit 201 onto the platen by the conveyance roller 205. At this time, the optical sensor 155 measures the specular reflection light intensity and the diffuse reflected light intensity of the roll paper 204, and the thickness and the roll paper width of the roll paper 204. The roll paper 204 after the printing is cut by the cutter unit 152 into a length desired by the user.

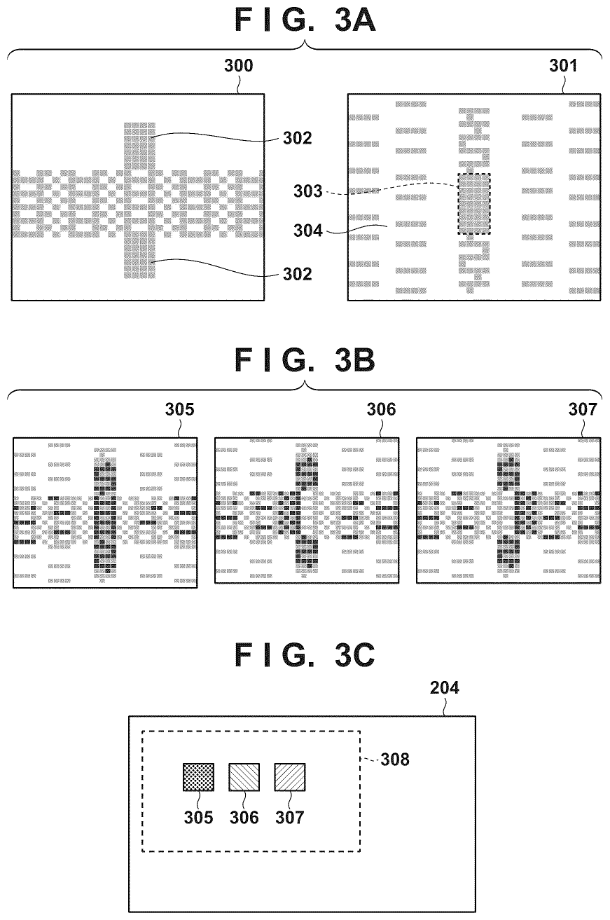

FIGS. 3A and 3B are schematic diagrams of the print alignment pattern according to the first embodiment. FIG. 3A is a view illustrating the first pattern and the second pattern.

The first pattern 300 is a print pattern of ink used for print alignment with a second pattern 301. The gray cells of the first pattern 300 indicate ink dots.

The second pattern 301 is a print pattern of a colorless and transparent processing liquid used for print alignment with the first pattern 300. The gray cells of the second pattern indicate dots of the colorless and transparent processing liquid.

A reference pattern 302 is a vertical linear pattern extending up and down in the first pattern 300. The reference pattern 302 is a pattern used for print alignment with an adjustment pattern 303 of the second pattern 301.

The adjustment pattern 303 is a pattern of a center surrounded by the dotted line of the second pattern 301. The adjustment pattern 303 is a partial pattern of the second pattern 301 formed to be shifted with respect to the first pattern 300. Specifically, the adjustment pattern 303 is formed to be shifted in the left-right direction (i.e., a direction orthogonal to the conveyance direction of the recording medium) of FIG. 3A.

A periodic pattern 304 is a pattern in which the adjustment pattern 303 is removed from the second pattern 301. The periodic pattern 304 has periodicity in which the ink and the processing liquid react optimally. In the present embodiment, printing is performed such that at least parts of the first pattern 300 and the second pattern 301 are in contact on the recording medium, and print alignment is performed by aligning the positions of the reference pattern 302 and the adjustment pattern 303. Hereinafter, the pattern formed by the first pattern 300 and the second pattern 301 is called a “print alignment pattern”.

FIG. 3B is a schematic diagram illustrating the print alignment pattern according to the first embodiment.

A print alignment pattern 305 is a pattern printed in a state where the print positions of the first pattern 300 and the second pattern 301 are aligned.

A print alignment pattern 306 is a pattern printed in a state where the second pattern 301 is shifted leftward by 3 dots with respect to the first pattern 300.

A print alignment pattern 307 is a pattern printed in a state where the second pattern 301 is shifted rightward by 3 dots with respect to the first pattern 300.

The black cells of the print alignment pattern 305, the print alignment pattern 306, and the print alignment pattern 307 indicate that the dots of the first pattern 300 and the dots of the second pattern 301 overlap. For example, when the processing liquid is used to obtain a good image without bleeding and density unevenness, the processing liquid optimally reacts at a position where the dots of the first pattern 300 and the dots of the second pattern 301 overlap, and therefore a printed material without bleeding and density unevenness can be obtained.

FIG. 3C is a schematic diagram of a plurality of print alignment patterns according to the first embodiment printed on a recording medium.

A print alignment pattern group 308 indicates a result of printing, on the roll paper 204, a plurality of print alignment patterns corresponding to a misalignment amount of the relative print position of the second pattern 301 with respect to the first pattern 300. More specifically, the print alignment pattern group 308 is a plurality of print alignment patterns formed on the recording medium by the recording apparatus 100 based on a “first print alignment mode”. In the first print alignment mode, only the adjustment pattern 303 of the second pattern 301 is formed to be shifted with respect to the first pattern 300. When there are three print alignment patterns constituting the print alignment pattern group 308, the recording apparatus 100 prints in the order of the print alignment pattern 305, the print alignment pattern 306, and the print alignment pattern 307.

For example, when visually performing print alignment, the user selects, via the input/output apparatus 162, the print alignment pattern in which the reference pattern 302 and the adjustment pattern 303 coincide with each other in the vertical direction (conveyance direction of the recording medium). Then, the input/output apparatus 162 transmits the correct print position based on the selected print alignment pattern to the recording apparatus 100. This enables the recording apparatus 100 to perform print alignment of the ink and the processing liquid.

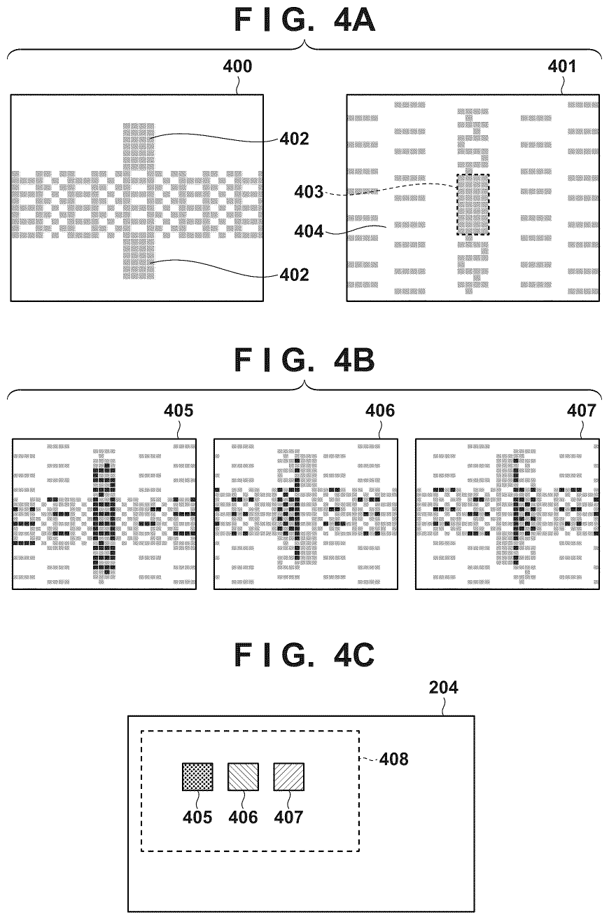

FIGS. 4A and 4B are schematic diagrams illustrating a print alignment pattern according to the prior art. FIG. 4A is a view illustrating the first pattern and the second pattern.

A first pattern 400 is a print pattern of ink used for print alignment with a second pattern 401. The gray cells of the first pattern 400 indicate ink dots.

The second pattern 401 is a print pattern of a colorless and transparent processing liquid used for print alignment with the first pattern 400. The gray cells of the second pattern indicate dots of the colorless and transparent processing liquid.

The first pattern 400 includes a reference pattern 402. The second pattern 401 includes an adjustment pattern 403 and a periodic pattern 404. The first pattern 400 has the same configuration as that of the first pattern 300 described above and the second pattern 401 has the same configuration as that of the second pattern 301 described above, and therefore a detailed description thereof will be omitted. A print alignment pattern 405 of FIG. 4B is the same as the print alignment pattern 305, and thus a detailed description thereof will be omitted.

A print alignment pattern 406 is a print alignment pattern formed by shifting the second pattern 401 leftward by 3 dots with respect to the first pattern 400.

A print alignment pattern 407 is a print alignment pattern formed by shifting the second pattern 401 rightward by 3 dots with respect to the first pattern 400.

The black cells of the print alignment pattern 406 and the print alignment pattern 407 indicate that the dots of the first pattern 400 and the dots of the second pattern 401 overlap.

For example, when the processing liquid is used to obtain a good image without bleeding and density unevenness, the processing liquid optimally reacts at a position where the dots of the first pattern 400 and the dots of the second pattern 401 overlap, and therefore a printed material without bleeding and density unevenness can be obtained.

FIG. 4C is a schematic diagram of a plurality of print alignment patterns according to the prior art printed on a recording medium.

A print alignment pattern group 408 indicates a result of printing, on the roll paper 204, a plurality of print alignment patterns corresponding to a misalignment amount of the relative print position of the second pattern 401 with respect to the first pattern 400. More specifically, the print alignment pattern group 408 is a plurality of print alignment patterns formed on the recording medium by the recording apparatus 100 based on a “second print alignment mode”. In the second print alignment mode, the second pattern 401 is formed to be entirely shifted with respect to the first pattern 400. When there are three print alignment patterns constituting the print alignment pattern group 408, the recording apparatus 100 prints in the order of the print alignment pattern 405, the print alignment pattern 406, and the print alignment pattern 407.

For example, when visually performing print alignment, the user selects, via the input/output apparatus 162, the pattern in which the reference pattern 402 and the adjustment pattern 403 coincide with each other in the vertical direction (conveyance direction of the recording medium). Then, the input/output apparatus 162 transmits the correct print position based on the selected print alignment pattern to the recording apparatus 100. This enables the recording apparatus 100 to perform print alignment of the ink and the processing liquid.

In a known case of observing the print alignment pattern 406 and the print alignment pattern 407 of FIGS. 4B and 4C, there has been a problem that the user has difficulty in understanding that the print positions of the ink and the processing liquid are shifted.

On the other hand, as described in FIG. 3B, in a case of observing the print alignment pattern 306 and the print alignment pattern 307 according to the present embodiment, it is easy for the user to understand that the print positions of the ink and the processing liquid are shifted.

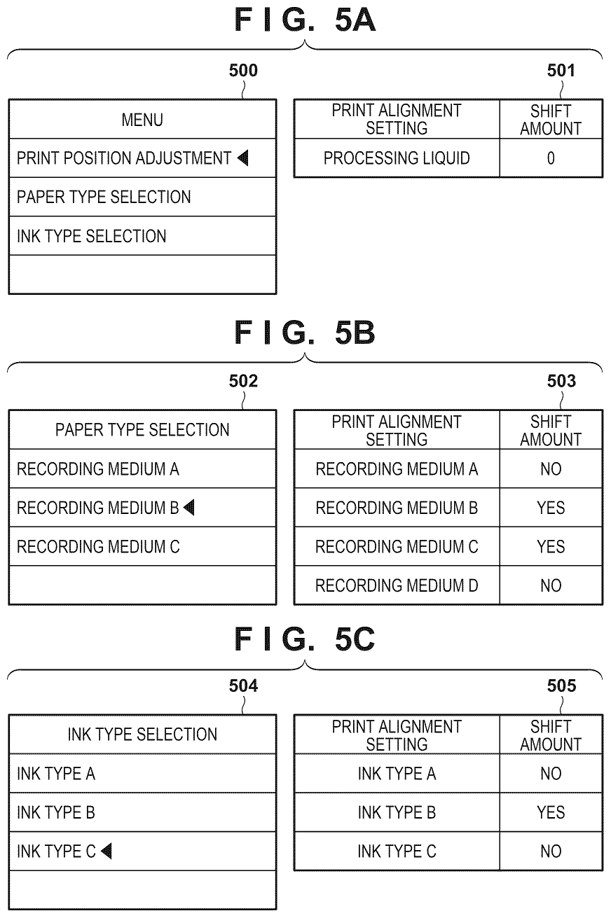

FIG. 5A is a view illustrating the setting of print alignment according to the first embodiment.

FIG. 5A illustrates a screen of the input/output apparatus 162 according to the first embodiment and the setting of print alignment stored in the HDD 161 and/or the flash ROM 123. A menu screen 500 indicates the setting of print alignment. The setting of print alignment includes, for example, settings of print position adjustment, paper type selection, and ink type selection. The user can execute print position adjustment via the menu screen 500. A print alignment setting 501 includes a setting of a shift amount of the adjustment pattern 303 with respect to the first pattern 300. The shift amount “0” indicates that the adjustment pattern 303 of the second pattern 301 is not shifted with respect to the reference pattern 302 of the first pattern 300.

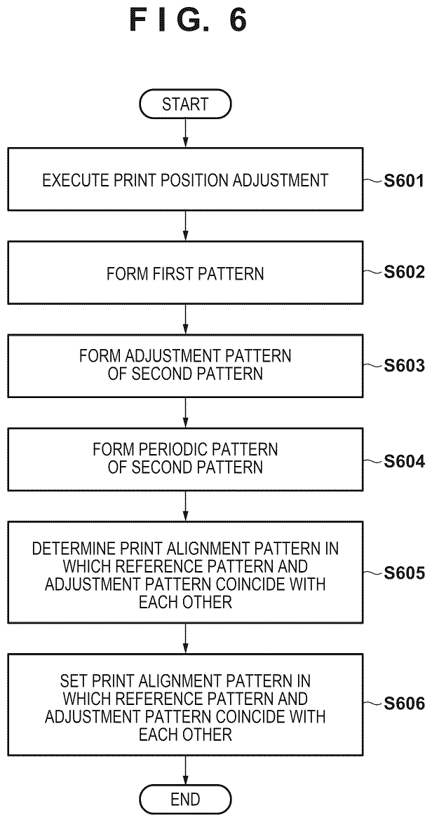

FIG. 6 is a flowchart showing the print position adjustment process according to the first embodiment.

When the user executes the print position adjustment of the menu screen 500 in S601, the host computer 190 sends a print start instruction to the host I/F 127. Upon receiving the print start instruction of the print alignment pattern group 308 from the host I/F 127, the CPU 128 starts the formation process the print alignment pattern group 308. Hereinafter, the recording apparatus 100 including the CPU 128 functions as a control apparatus and performs the process of FIG. 6, but the host computer 190 may function as a control apparatus and perform the process of FIG. 6. The recording apparatus 100 and the host computer 190 may cooperatively execute the process of FIG. 6.

In S602, the CPU 128 prints, on the roll paper 204, the first pattern 300 of the print alignment pattern 305, the print alignment pattern 306, and the print alignment pattern 307 of the print alignment pattern group 308, and proceeds with the process to S603.

In S603, the CPU 128 forms, on the roll paper 204, the adjustment pattern 303 of the second pattern 301 of the print alignment pattern 305, the print alignment pattern 306, and the print alignment pattern 307, and proceeds with the process to S604. At this time, the adjustment pattern 303 of the print alignment pattern 305 is formed without being shifted in the left-right direction with respect to the first pattern 300. The adjustment pattern 303 of the print alignment pattern 306 is formed to be shifted leftward by 3 dots with respect to the first pattern 300. The adjustment pattern 303 of the print alignment pattern 307 is formed to be shifted rightward by 3 dots with respect to the first pattern 300.

In S604, the CPU 128 prints, on the roll paper 204, the periodic pattern 304 of the second pattern 301 of the print alignment pattern 305, the print alignment pattern 306, and the print alignment pattern 307 without being shifted with respect to the first pattern 300, and proceeds with the process to S605.

In this manner, since only the adjustment pattern 303 of the second pattern 301 is formed to be shifted with respect to the first pattern 300 and the periodic pattern 304 is formed without being shifted, an optimum reaction between the ink and the processing liquid can be obtained.

Note that the first pattern 300, the adjustment pattern 303, and the periodic pattern 304 may be stored in advance in the HDD 161 and/or the flash ROM 123, or may be generated by the CPU 128 at the time of executing the process of FIG. 6. For example, when the first pattern 300, the adjustment pattern 303, and the periodic pattern 304 are generated at the time of executing the process of FIG. 6, the reference pattern 302 is generated by repeating a pattern of 4 dots horizontally in the vertical direction 6 times from a position shifted by 4 dots from the top of the first pattern 300 and 2 dots leftward from the pattern center in the horizontal direction. This reduces the recording capacity of the pattern to be stored in the HDD 161 and/or the flash ROM 123.

In S604, using the optical sensor 155, the CPU 128 measures the print alignment pattern 305, the print alignment pattern 306, and the print alignment pattern 307 printed on the roll paper 204. Then, based on the measurement result of the optical sensor 155, the CPU 128 determines a print alignment pattern in which the reference pattern 302 and the adjustment pattern 303 coincide with each other in the vertical direction (specifically, the conveyance direction of the roll paper 204, which is a recording medium), and proceeds with the process to S606.

For example, when the print positions of the ink and the processing liquid are not relatively shifted, the print alignment pattern in which the reference pattern 302 and the adjustment pattern 303 coincide with each other in the vertical direction is the print alignment pattern 305. On the other hand, when the print positions of the ink and the processing liquid are relatively shifted leftward by 3 dots, the print alignment pattern in which the reference pattern 302 and the adjustment pattern 303 coincide with each other in the vertical direction is the print alignment pattern 306. Then, when the print positions of the ink and the processing liquid are relatively shifted rightward by 3 dots, the print alignment pattern in which the reference pattern 302 and the adjustment pattern 303 coincide with each other in the vertical direction is the print alignment pattern 307. Note that an appropriate print alignment pattern may be determined from among the print alignment pattern group 308 without using the optical sensor 155. That is, the user visually determines the print alignment pattern in which the reference pattern and the adjustment pattern coincide with each other in the vertical direction, and the CPU 128 can acquire the print alignment pattern in which the reference pattern and the adjustment pattern coincide with each other in the vertical direction based on the determination result (user input) of the user.

In S606, the CPU 128 stores, in the print alignment setting 501 of the HDD 161 and/or the flash ROM 123, the print alignment pattern in which the reference pattern 302 and the adjustment pattern 303 coincide with each other in the vertical direction, and ends the process.

For example, the shift amount corresponding to a state in which the print positions of the ink and the processing liquid are not relatively shifted (i.e., the print alignment pattern 305) is assumed to be 0.

With reference to the shift amount 0 of the print alignment pattern 305, the shift amount of the print alignment pattern 306 is +3, and the shift amount of the print alignment pattern 307 is −3.

In this manner, by forming the adjustment pattern 303 of the second pattern 301 to be shifted with respect to the first pattern 300, it is possible to achieve print alignment for obtaining a reaction suitable for the ink and the processing liquid.

### Second Embodiment

In the second embodiment, print alignment of the ink and the processing liquid is performed by switching between the first print alignment mode and the second print alignment mode in accordance with the paper type selected by the user. In the second embodiment, only a difference from the first embodiment will be described.

FIG. 5B illustrates a screen of the input/output apparatus 162 of the second embodiment and the print alignment setting.

A paper type selection screen 502 is a screen on which the user selects the type of recording medium. The type of recording medium include normal paper, recycled paper, quality paper, coated paper, matt coated paper, and special paper. A print alignment setting 503 is a setting that defines a correspondence relationship between the recording medium and the influence of the periodic pattern. “No” of the shift amount in the print alignment setting 503 indicates the second print alignment mode. In the second print alignment mode, the second pattern 401 is formed to be entirely shifted with respect to the first pattern 400. On the other hand, “Yes” of the shift amount of the print alignment setting 503 indicates the first print alignment mode. In the first print alignment mode, only the adjustment pattern 303 of the second pattern 301 is formed to be shifted with respect to the first pattern 300.

For example, when a periodic pattern is formed on a recording medium for the purpose of optimally reacting the ink and the processing liquid, a pattern optimized for the ink is formed. Special paper provided with an ink receptive layer on the surface has little ink bleeding, and therefore the periodic pattern of the processing liquid has a small influence on the print quality. That is, the special paper is a recording medium corresponding to “No” of the shift amount, that is, the second print alignment mode (Recording media A and D). On the other hand, in normal paper not provided with an ink receptive layer on the surface, the processing liquid improves the water resistance of the normal paper, and therefore the periodic pattern of the processing liquid has a large influence on the print quality. That is, the normal paper is a recording medium corresponding to “Yes” of the shift amount, that is, the first print alignment mode (Recording media B and C).

As described above, the paper type selected on the paper type selection screen 502 by the user is transmitted to the recording apparatus 100 at the time of feeding paper in consideration of the influence of the processing liquid on the print quality. Then, the recording apparatus 100 can determine the print alignment mode suitable for the paper type selected by the user from the setting 503, and can form, on the recording medium, a print alignment pattern based on the determined print alignment mode.

In the present embodiment, the recording apparatus 100 prints the print alignment pattern group 308 when the periodic pattern of the processing liquid has a large influence on the print quality (when corresponding to “Yes” of the shift amount). On the other hand, the recording apparatus 100 prints the print alignment pattern group 408 when the periodic pattern of the processing liquid has a small influence on the print quality (when corresponding to “No” of the shift amount). The value of the setting 503 is stored in advance in the HDD 161 and/or the flash ROM 123.

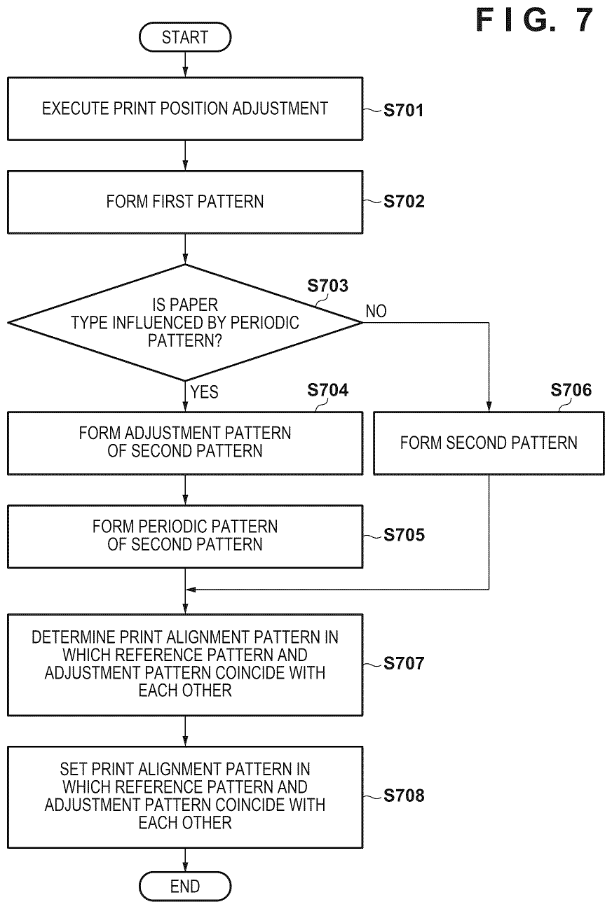

FIG. 7 is a flowchart showing the print position adjustment process according to the second embodiment.

When the user executes the print position adjustment from the menu screen 500 in S701, the host computer 190 transmits a print start instruction to the host I/F 127. Upon receiving the print start instruction of the print alignment pattern group 308 from the host I/F 127, the CPU 128 starts the formation process the print alignment pattern group 308. Note that when the print position adjustment is executed, the formation process of not the print alignment pattern group 308 but the print alignment pattern group 408 may be executed. For example, the user can set in advance as to which of the print alignment pattern group 308 and the print alignment pattern group 408 to execute in the initial setting of the print position adjustment of the menu screen 500. Here, for ease of description, it is assumed that the print alignment pattern group 308 of the first print alignment mode is set as the initial setting of the print position adjustment of the menu screen 500.

In S702, the CPU 128 prints, on the roll paper 204, the first pattern 300 of the print alignment pattern 305, the print alignment pattern 306, and the print alignment pattern 307, and proceeds with the process to S703.

In S703, the CPU 128 acquires, from the print alignment setting 503, the influence (specifically, information indicating whether or not shift of only the periodic pattern occurs) of the periodic pattern of the processing liquid on the recording medium selected on the paper type selection screen 502 by the user at the time of feeding paper. The CPU 128 determines whether or not the periodic pattern of the processing liquid has an influence on the recording medium of the user selection. Upon determining that the periodic pattern of the processing liquid has an influence on the recording medium of the user selection (Yes in S703), the CPU 128 maintains the first print alignment mode and proceeds with the process to S704. On the other hand, upon determining that the periodic pattern of the processing liquid has no influence on the recording medium of the user selection (No in S703), the CPU 128 changes from the first print alignment mode to the second print alignment mode, and proceeds with the process to S706.

In S704, the CPU 128 forms, on the roll paper 204, the adjustment pattern 303 of the second pattern 301 of the print alignment pattern 305, the print alignment pattern 306, and the print alignment pattern 307, and proceeds with the process to S705. At this time, the adjustment pattern 303 of the print alignment pattern 305 is formed without being shifted with respect to the first pattern 300. The adjustment pattern 303 of the print alignment pattern 306 is formed to be shifted leftward by 3 dots with respect to the first pattern 300. The adjustment pattern 303 of the print alignment pattern 307 is formed to be shifted rightward by 3 dots with respect to the first pattern 300.

In S705, the CPU 128 prints, on the roll paper 204, the periodic pattern 304 of the second pattern 301 of the print alignment pattern 305, the print alignment pattern 306, and the print alignment pattern 307 without being shifted with respect to the first pattern 300, and proceeds with the process to S707.

In S706, the CPU 128 forms, on the roll paper 204, the print alignment pattern 405, the print alignment pattern 406, and the print alignment pattern 407, and proceeds with the process to S707. At this time, the second pattern 401 of the print alignment pattern 406 is formed to be shifted leftward by 3 dots with respect to the first pattern 400. Then, the second pattern 401 of the print alignment pattern 407 is formed to be shifted rightward by 3 dots with respect to the first pattern 400. In this manner, when the periodic pattern of the processing liquid has a small influence on the print quality (when the paper type of the user selection corresponds to the second print alignment mode), it is not necessary to separately execute the formation process of the adjustment pattern and the formation process of the periodic pattern with respect to the formation process of the second pattern, and therefore it is possible to simplify the formation process of the second pattern. This can shorten the formation process time of the second pattern in the case where the size of the second pattern is large, in the case where the second pattern is complicated, and in the case where the number of the second patterns is large.

Note that the first pattern 300, the adjustment pattern 303, and the periodic pattern 304 of the first print alignment mode may be stored in advance in the HDD 161 and/or the flash ROM 123, or may be generated by the CPU 128 at the time of executing the process of FIG. 7. Here, an example of processing applied to the first print alignment mode will be described, but this processing can be applied to the second print alignment mode. For example, when the first pattern 300, the adjustment pattern 303, and the periodic pattern 304 are generated at the time of executing the process of FIG. 7, the reference pattern 302 can be generated by repeating a pattern of 4 dots horizontally in the vertical direction 6 times from a position shifted by 4 dots from the top of the first pattern 300 and 2 dots leftward from the pattern center in the horizontal direction. This reduces the recording capacity of the pattern to be stored in the HDD 161 and/or the flash ROM 123.

In S707, using the optical sensor 155, the CPU 128 measures the print alignment pattern group 308 or the print alignment pattern group 408 printed on the roll paper 204. Then, the CPU 128 determines a print alignment pattern in which the reference pattern and the adjustment pattern coincide with each other in the vertical direction (specifically, the conveyance direction of the roll paper 204, which is a recording medium), and proceeds with the process to S708.

For example, the print alignment pattern when the print positions of the ink and the processing liquid are not relatively shifted is the print alignment pattern 305 or the print alignment pattern 405. On the other hand, the print alignment pattern when the print positions of the ink and the processing liquid are relatively shifted leftward by 3 dots is the print alignment pattern 306 or the print alignment pattern 406. Then, the print alignment pattern in the case of a state where the print positions of the ink and the processing liquid are relatively shifted rightward by 3 dots is the print alignment pattern 307 or the print alignment pattern 407. Note that an appropriate print alignment pattern may be determined from among the print alignment pattern group 308 or the print alignment pattern group 408 without using the optical sensor 155. That is, the user visually determines the print alignment pattern in which the reference pattern and the adjustment pattern coincide with each other in the vertical direction, and the CPU 128 can acquire the print alignment pattern in which the reference pattern and the adjustment pattern coincide with each other in the vertical direction based on the determination result (user input) of the user.

In S708, the CPU 128 stores, in the print alignment setting 501 of the HDD 161 and/or the flash ROM 123, the print alignment pattern in which the reference pattern and the adjustment pattern coincide with each other in the vertical direction, and ends the process.

According to the second embodiment, by switching between the first print alignment mode and the second print alignment mode in accordance with the paper type of the user selection, it is possible to achieve print alignment of the ink and the processing liquid in consideration of the influence of the periodic pattern of the second pattern.

### Third Embodiment

In the third embodiment, print alignment of the ink and the processing liquid is performed by switching between the first print alignment mode and the second print alignment mode in accordance with the ink type selected by the user. Note that in the third embodiment, only differences from the first and second embodiments will be described.

FIG. 5C illustrates a screen of the input/output apparatus 162 of the third embodiment and the print alignment setting.

An ink type selection screen 504 is a screen on which the user selects the type of the ink to be ejected from the inkjet head 151. A print alignment setting 505 is a setting that defines a correspondence relationship between the ink type and the influence of the periodic pattern. “No” of the shift amount in the print alignment setting 505 indicates the second print alignment mode. In the second print alignment mode, the second pattern 401 is formed to be entirely shifted with respect to the first pattern 400. On the other hand, “Yes” of the shift amount of the print alignment setting 503 indicates the first print alignment mode. In the first print alignment mode, only the adjustment pattern 303 of the second pattern 301 is formed to be shifted with respect to the first pattern 300. For example, when the purpose is to cause thickening or gelation by mixing the processing liquid with color ink, the reaction liquid of the processing liquid varies depending on the ink type, and thus the influence of the periodic pattern on the print quality also varies.

For example, when the processing liquid has a periodic pattern optimized to a pattern of ink that hardly gels, the following problems occur. For example, when the periodic pattern of the processing liquid changes, the density of the processing liquid intended for the ink cannot be obtained. Since the processing liquid permeates the recording medium before the ink, the ink is not fixed to the recording medium. As a result, the ink and the ink are attracted to each other, and bleeding occurs. In the case of using ink that hardly gels, the periodic pattern of the processing liquid has a large influence on the print quality, and thus, it is preferable to use the “ink type B” corresponding to the shift amount “Yes”. On the other hand, since the bleeding problem as described above does not occur in the ink that easily gels, it is preferable to use the ink types A and C corresponding to the shift amount “No”.

As described above, the ink type selected from the ink type selection screen 504 by the user is transmitted to the recording apparatus 100 at the time of mounting the ink in consideration of the influence of the processing liquid on the print quality. This enables the recording apparatus 100 to determine a print alignment mode suitable for the ink type selected by the user from the print alignment setting 505, and form, on the recording medium, a print alignment pattern based on the determined print alignment mode. Note that the value of the print alignment setting 505 is stored in advance in the HDD 161 and/or the flash ROM 123.

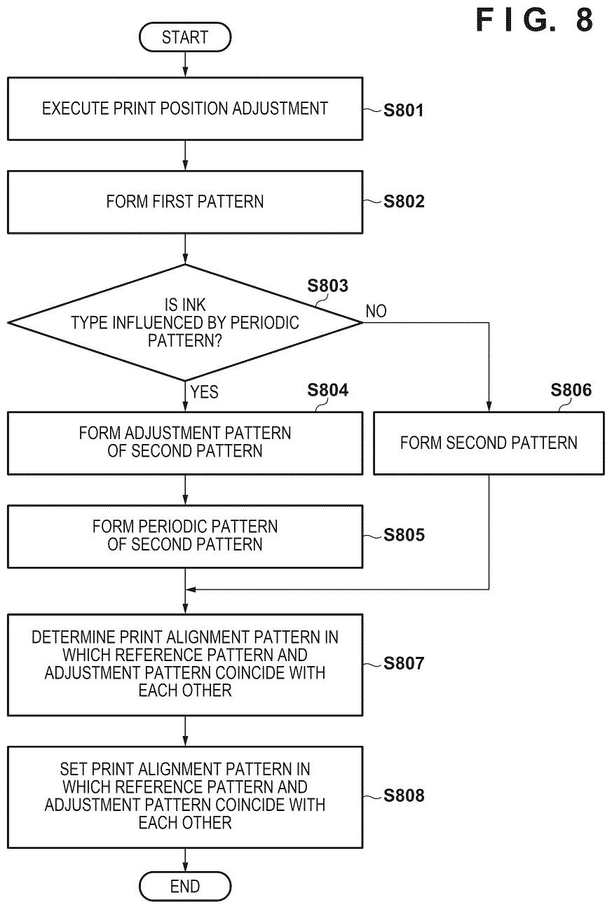

FIG. 8 is a flowchart showing the print position adjustment process according to the third embodiment.

When the user executes the print position adjustment from the menu screen 500 in S801, the host computer 190 sends a print start instruction to the host I/F 127. Upon receiving the print start instruction of the print alignment pattern group 308 from the host I/F 127, the CPU 128 starts the formation process the print alignment pattern group 308. Note that when the print position adjustment is executed, the formation process of not the print alignment pattern group 308 but the print alignment pattern group 408 may be executed. For example, the user can set in advance as to which of the print alignment pattern group 308 and the print alignment pattern group 408 to execute in the initial setting of the print position adjustment of the menu screen 500. Here, for ease of description, it is assumed that the print alignment pattern group 308 of the first print alignment mode is set as the initial setting of the print position adjustment of the menu screen 500.

In S802, the CPU 128 prints, on the roll paper 204, the first pattern 300 of the print alignment pattern 305, the print alignment pattern 306, and the print alignment pattern 307 of the print alignment pattern group 308, and proceeds with the process to S803.

In S803, the CPU 128 acquires, from the print alignment setting 505, the influence (specifically, information indicating whether or not shift of only the periodic pattern occurs) of the periodic pattern of the processing liquid on the ink type selected on the ink type selection screen 504 by the user. The CPU 128 determines whether or not the periodic pattern of the processing liquid has an influence on the ink type of the user selection. Upon determining that the periodic pattern of the processing liquid has an influence on the ink type of the user selection (Yes in S803), the CPU 128 maintains the first print alignment mode and proceeds with the process to S804. On the other hand, upon determining that the periodic pattern of the processing liquid has no influence on the ink type of the user selection (No in S803), the CPU 128 changes from the first print alignment mode to the second print alignment mode, and proceeds with the process to S806. In S804, the CPU 128 forms, on the roll paper 204, the adjustment pattern 303 of the second pattern 301 of the print alignment pattern 305, the print alignment pattern 306, and the print alignment pattern 307, and proceeds with the process to S805. At this time, the adjustment pattern 303 of the print alignment pattern 305 is formed without being shifted with respect to the first pattern 300. The adjustment pattern 303 of the print alignment pattern 306 is formed to be shifted leftward by 3 dots with respect to the first pattern 300. The adjustment pattern 303 of the print alignment pattern 307 is formed to be shifted rightward by 3 dots with respect to the first pattern 300.

In S805, the CPU 128 prints, on the roll paper 204, the periodic pattern 304 of the second pattern 301 of the print alignment pattern 305, the print alignment pattern 306, and the print alignment pattern 307 without being shifted with respect to the first pattern 300, and proceeds with the process to S807.

In S806, the CPU 128 forms, on the roll paper 204, the print alignment pattern 405, the print alignment pattern 406, and the print alignment pattern 407, and proceeds with the process to S807. At this time, the second pattern 401 of the print alignment pattern 406 is formed to be shifted leftward by 3 dots with respect to the first pattern 400. Then, the second pattern 401 of the print alignment pattern 407 is formed to be shifted rightward by 3 dots with respect to the first pattern 400. When the periodicity of the processing liquid has a small influence with respect to the ink type of the user selection (when the ink type of the user selection corresponds to the second print alignment mode), it is not necessary to separately execute the formation process of the adjustment pattern and the formation process of the periodic pattern with respect to the formation process of the second pattern, and therefore it is possible to simplify the formation process of the second pattern. This can shorten the formation process time of the second pattern in the case where the size of the second pattern is large, in the case where the second pattern is complicated, and in the case where the number of the second patterns is large.

Note that the first pattern 300, the adjustment pattern 303, and the periodic pattern 304 may be stored in advance in the HDD 161 and/or the flash ROM 123, or may be generated at the time of executing the process of FIG. 8. Here, an example of processing applied to the first print alignment mode will be described, but this processing can be applied to the second print alignment mode. For example, when the first pattern 300, the adjustment pattern 303, and the periodic pattern 304 are generated at the time of executing the process of FIG. 8, the reference pattern 302 can be generated by repeating a pattern of 4 dots horizontally in the vertical direction 6 times from a position shifted by 4 dots from the top of the first pattern 300 and 2 dots leftward from the pattern center in the horizontal direction. This reduces the recording capacity of the pattern to be stored in the HDD 161 and/or the flash ROM 123.

In S807, using the optical sensor 155, the CPU 128 measures the print alignment pattern group 308 or the print alignment pattern group 408 printed on the roll paper 204. Then, based on the measurement result of the optical sensor 155, the CPU 128 determines a print alignment pattern in which the reference pattern and the adjustment pattern coincide with each other in the vertical direction (specifically, the conveyance direction of the roll paper 204, which is a recording medium), and proceeds with the process to S608.

For example, the print alignment pattern when the print positions of the ink and the processing liquid are not relatively shifted is the print alignment pattern 305 or the print alignment pattern 405 in which the reference pattern and the adjustment pattern coincide with each other in the vertical direction. On the other hand, the print alignment pattern when the print positions of the ink and the processing liquid are relatively shifted leftward by 3 dots is the print alignment pattern 306 or the print alignment pattern 406. Then, the print alignment pattern when the print positions of the ink and the processing liquid are relatively shifted rightward by 3 dots is the print alignment pattern 307 or the print alignment pattern 407. Note that an appropriate print alignment pattern may be determined from among the print alignment pattern group 308 or the print alignment pattern group 408 without using the optical sensor 155. That is, the user visually determines the print alignment pattern in which the reference pattern and the adjustment pattern coincide with each other in the vertical direction, and the CPU 128 can acquire the print alignment pattern in which the reference pattern and the adjustment pattern coincide with each other in the vertical direction based on the determination result (user input) of the user.

In S808, the CPU 128 stores, in the setting 501 of the HDD 161 and/or the flash ROM 123, the print alignment pattern in which the reference pattern and the adjustment pattern coincide with each other in the vertical direction, and ends the process.

As described above, according to the third embodiment, by switching between the first print alignment mode and the second print alignment mode in accordance with the ink type of the user selection, it is possible to achieve print alignment of the ink and the processing liquid in consideration of the influence of the periodic pattern of the second pattern.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-076086, filed May 8, 2024 which is hereby incorporated by reference herein in their entirety.

What is claimed is:

1. A control apparatus comprising:
at least one processor; and
at least one memory coupled to the at least one processor, the at least one memory storing instructions that, when executed by the at least one processor, cause the at least one processor to:
perform control of forming a plurality of print alignment patterns on a recording medium based on a first print alignment mode in which a second pattern formed with a processing liquid based on second image data is formed to be partially shifted with respect to a first pattern formed with ink based on first image data, wherein
the first pattern includes a reference pattern used for alignment with the second pattern,
the second pattern includes an adjustment pattern used for alignment with the first pattern and a periodic pattern in which the ink and the processing liquid react with each other, and
a part of the second pattern formed to be partially shifted is the adjustment pattern.

2. The control apparatus according to claim 1, wherein
the at least one processor performs control of forming the plurality of print alignment patterns on the recording medium based on the first print alignment mode determined based on a predetermined setting or a second print alignment mode in which the second pattern is formed to be entirely shifted with respect to the first pattern.

3. The control apparatus according to claim 2, wherein
the predetermined setting includes a type of the recording medium, and
the type of the recording medium corresponds to the first print alignment mode or the second print alignment mode.

4. The control apparatus according to claim 2, wherein
the predetermined setting includes a type of the ink, and
the type of the ink corresponds to the first print alignment mode or the second print alignment mode.

5. The control apparatus according to claim 1, wherein the instructions, when executed by the at least one processor, further cause the at least one processor to determine a print alignment pattern in which the reference pattern and the adjustment pattern match in a predetermined direction of the recording medium from among the plurality of print alignment patterns using an optical sensor or based on a user input.

6. The control apparatus according to claim 5, wherein
the predetermined direction is a conveyance direction of the recording medium.

7. The control apparatus according to claim 5, wherein the instructions, when executed by the at least one processor, further cause the at least one processor to store the print alignment pattern determined by the at least one processor.

8. The control apparatus according to claim 2 further comprising:
a display unit configured to display, on a screen, a setting of print alignment of the ink and the processing liquid; and
an input unit configured to input the predetermined setting from among the setting of print alignment displayed on the screen.

9. The control apparatus according to claim 1, wherein
the part of the second pattern formed to be partially shifted is formed to be shifted in a direction orthogonal to a conveyance direction of the recording medium.

10. A recording apparatus comprising:
a print unit configured to print an image; and
the control apparatus according to claim 1.

11. A method comprising:
performing control of forming a plurality of print alignment patterns on a recording medium based on a first print alignment mode in which a second pattern formed with a processing liquid based on second image data is formed to be partially shifted with respect to a first pattern formed with ink based on first image data, wherein
the first pattern includes a reference pattern used for alignment with the second pattern,
the second pattern includes an adjustment pattern used for alignment with the first pattern and a periodic pattern in which the ink and the processing liquid react with each other, and
a part of the second pattern formed to be partially shifted is the adjustment pattern.

12. A non-transitory computer readable storage medium storing instructions that, when executed by a computer, cause the computer to perform a method comprising:
performing control of forming a plurality of print alignment patterns on a recording medium based on a first print alignment mode in which a second pattern formed with a processing liquid based on second image data is formed to be partially shifted with respect to a first pattern formed with ink based on first image data, wherein
the first pattern includes a reference pattern used for alignment with the second pattern,
the second pattern includes an adjustment pattern used for alignment with the first pattern and a periodic pattern in which the ink and the processing liquid react with each other, and
a part of the second pattern formed to be partially shifted is the adjustment pattern.
